(19) United States
(12) Patent Application Publication
(10) Pub. No.: US 2019/0368286 A1
(43) Pub. Date: Dec. 5, 2019

(54) TORQUE TURN LOGGER

(71) Applicant: Schlumberger Technology Corporation, Sugar Land, TX (US)

(72) Inventor: Anstein Jorud, Kristiansand (NO)

(21) Appl. No.: 15/994,578

(22) Filed: May 31, 2018

(51) Int. Cl. E21B 19/16; E21B 44/04; E21B 47/12

(52) U.S. Cl. CPC E21B 19/166; G01D 9/005; E21B 47/124; E21B 44/04

(57) ABSTRACT

A torque turn system for making pipe joints of tubulars in a drill string relative to a drilling rig, the torque turn system comprising a rotation sensor, a torque sensor, a torque turn server that receives and processes real-time rotation and torque data, and a torque turn analyzer that generates a graphical user interface (GUI), the GUI comprising: a rotation data output component having a plot of the rotation data as a function of turns; a torque data output component having a plot of the torque data as a function of turns; an accept input component; and a reject input component.

### TECHNICAL FIELD

The present disclosure relates to control systems for drilling for hydrocarbons and other formation fluids and gases. In particular, the disclosure relates to a torque turn system to sample, record, and report torque verses turns during as pipe tubular sections are made-up in casing or drill string.

### BACKGROUND

During drilling operations, drill string is run into a well bore and is made up of a series of connected drill pipes. As the drill string is tripped into the wellbore, additional pipes are added to the top of the drill string to lengthen the string. The drill string is lowered in the wellbore until only an uppermost portion of the drill string sticks up above the drill floor. The distance the upper end of the drill string extends above the drill floor is called the “stick-up height.” When the drill string is positioned at an appropriate “stick-up height” for making up a new section of drill pipe to the drill string, pipe handling equipment position the new section of drill pipe in axial alignment with the drill string immediately above the string. The new section of drill pipe is lowered until the pin end of the new section stings into the box end of the drill string. The new section of drill pipe is then rotated relative to the drill string so as to engage the threads of the pin and box ends to form a pipe joint. An iron roughneck is then positioned at the pipe joint to apply sufficient torque to make up the joint. Typically, the threads are engaged by a low-torque pipe spinner and the joint is made up by mechanical tongs of an iron roughneck, which apply high-torque to the joint to ensure a complete and durable connection where the shoulders of the box and pin fully engage.

“Torque-turn” systems have been used to determine whether satisfactory threaded connections are made up at the pipe joints. A specified number of threads have to be engaged and a specific torque applied for the pipe joints to be leak proof. “Torque-turn” systems measure torque and count the number of turns during make-up of threaded connections.

U.S. Pat. No. 3,368,396 discloses an example “torque turn” system for monitoring torque and turns during make-up operations.

U.S. Pat. No. 4,962,579 describes the “torque turn” method as being extremely sensitive to a reference torque, which is a relatively low value, typically 10 percent (10%) of the minimum torque. This torque is sometimes determined by API torque recommendations. After this reference torque is reached, a predetermined number of turns are counted in the make-up of the tubular connection. If a false reference torque occurs to activate the turn counter, an improper joint make-up will result.

US Publication No. 2017/0030181 discloses user interface views or displays to provide the user with information about when a downhole tool was bade-up, when the tool was inspected and the like. A “make-up” link in the user interface may provide access to information about when the downhole tool was made-up and coupled to other components of a drill string. Such information may include the torque applied to make-up the downhole tool, any compounds added to the threads to make-up the torque, the type of equipment used to make-up the connection (e.g., power tongs, iron roughneck, etc.), the clamping force applied when making-up the connection, the identification of other components to which the component was attached, and the like.

A brochure, published in 2014 by Cameron and titled “Torque/Turn System Ontrack” (https://cameron.slb.com/-/media/cam/resources/2014/.../torque-turn-system-flyer.ashx), discloses a torque turn system. The system allows for approval of casing connections by a casing supervisor on a computer/laptop. The system generates torque/turn and torque/time graphs, as well as a separate speed/time graph displayed below to show rpm related to time. The operator will be able to set shoulder torque in the graph before accepting (or rejecting) the connection. The system then generates a torque/turn report as shown in FIG. 1.

While prior torque turn systems monitor and record the torque and turns of make-up operations, they do not allow real-time visualization of the casing make-up operation and calculated connection data for approval/disapproval of pipe joints as new pipe sections are made up in the string. In view of prior systems, there is a need for a torque turn system that provides real-time approval authority during make-up operations.

### SUMMARY

In accordance with the teachings of the present disclosure, disadvantages and problems associated with existing drill rig control systems are alleviated.

According to one aspect, there is provided a torque turn system for making pipe joints of tubulars in a drill string relative to a drilling rig, the torque turn system comprising: a sensor of rotation of a first tubular relative to a second tubular; a sensor of torque applied to a first tubular relative to a second tubular; a torque turn server in data communication with the sensor of rotation and the sensor of torque, the torque turn server comprising a processor, a non-transitory storage medium, a transmitter/receiver, and a set of computer readable instructions stored in the non-transitory storage medium and when executed by the processor: (i) receive and process real-time rotation data from the sensor of rotation; and (ii) receive and process real-time torque data from the sensor of torque; a torque turn analyzer in data communication with the torque turn server, the torque turn analyzer comprising a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising: a rotation data output component; a torque data output component; an accept input component; and a reject input component.

Another aspect provides a torque turn method for making a pipe joint of tubulars in a drill string relative to a drilling rig, the torque turn method comprising: making up a joint between two tubulars by spinning the tubulars relative to each other and applying torque to the tubulars relative to each other; sensing tubular relative rotation and tubular relative torque to obtain rotation data and torque data; generating a graphic user interface (GUI) comprising: a rotation data output component; a torque data output component; an accept input component; and a reject input component.

A torque turn system for making a pipe joint of tubulars in a drill string relative to a drilling rig, the torque turn system comprising: a sensor of rotation of a first tubular relative to a second tubular; a sensor of torque applied to a first tubular relative to a second tubular; a torque turn server in data communication with the sensor of rotation and the sensor of torque, the torque turn server comprising a processor, a non-transitory storage medium, a transmitter/receiver, and a set of computer readable instructions stored in the non-transitory storage medium and when executed by the processor: (i) receive and process real-time rotation data from the sensor of rotation; and (ii) receive and process real-time torque data from the sensor of torque; and a torque turn analyzer in data communication with the torque turn server, the torque turn analyzer comprising a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising: a rotation data output component, wherein the rotation data output component comprises a plot of the rotation data as a function of turns; a torque data output component, wherein the torque data output component comprises a plot of the torque data as a function of turns; an accept input component; a reject input component; a real-time rotation data output component, wherein the real-time rotation data output component comprises a plot of rotation data as a function of time; and a real-time torque data output component, wherein the real-time torque data output component comprises a plot of torque data as a function of time.

### BRIEF DESCRIPTION OF DRAWINGS

A more complete understanding of the present embodiments may be acquired by referring to the following description taken in conjunction with the accompanying drawings, in which like reference numbers indicate like features.

FIG. 1 is an illustration of a prior art torque/turn report.

FIG. 2 is a perspective view of an iron roughneck with rotation and torque sensors, wherein the roughneck is in an idle position relative to a tubular pipe joint.

FIG. 3 is a schematic illustration of a torque turn system having sensors, a torque turn server, and three torque turn analyzers all communicating via a network.

FIG. 4 is an illustration of a graphic user interface (GUI) showing output components for real-time speed and torque data as a function of time.

FIG. 5 is an illustration of a graphic user interface (GUI) showing “accept” and “reject” input components and showing output components for speed and torque as a function of turns.

FIG. 6 is an illustration of a graphic user interface (GUI) showing input components for identification information.

FIG. 7 is an illustration of a graphic user interface (GUI) showing output components for section data as a function of connections and turns.

FIG. 8 is an illustration of a graphic user interface (GUI) showing output components for distribution data for number of connections as a function of torque.

FIG. 9 is a flowchart related to embodiments described herein.

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DESCRIPTION OF EMBODIMENTS

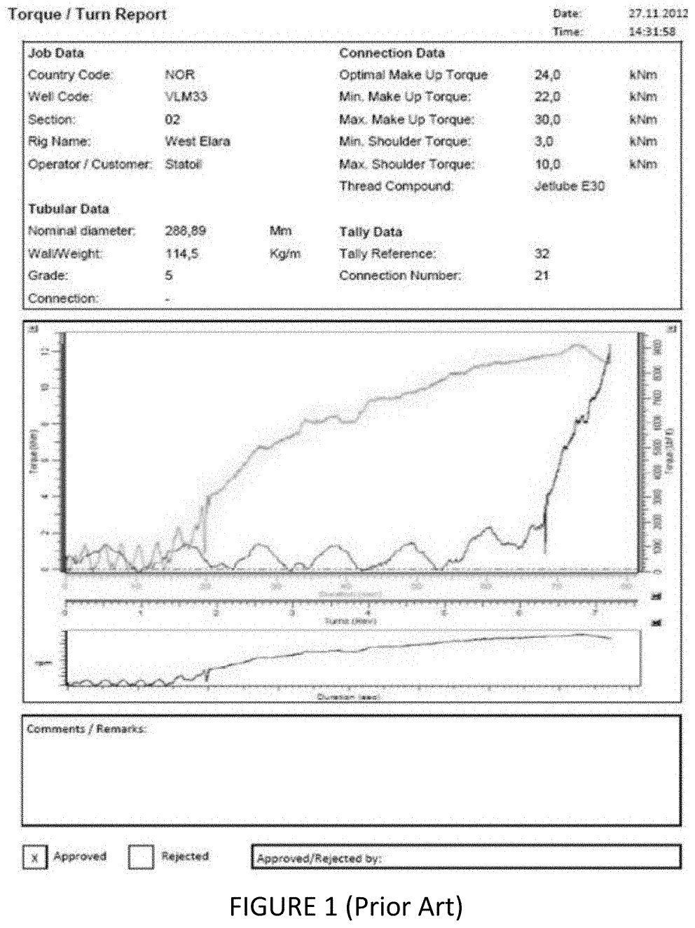

Some embodiments are best understood by reference to FIGS. 1-4 below in view of the following general discussion. The present disclosure may be more easily understood in the context of a high level description of certain embodiments.

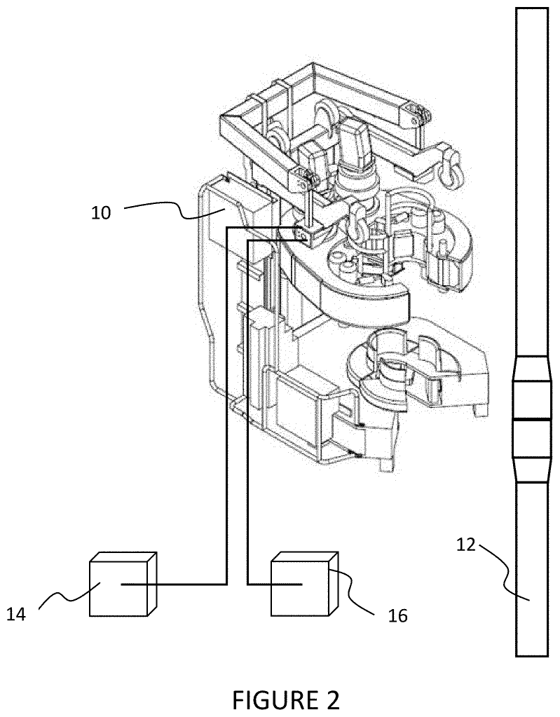

FIG. 2 is a perspective view of an iron roughneck 10 positioned adjacent a drill string 12 having a joint of two tubular sections of the string. A torque sensor 14 monitors the amount of torque applied to the joint by the roughneck 10. A turn sensor 16 monitors the number of rotations the tubular sections make relative to each other. Additional sensors may also be included in the system.

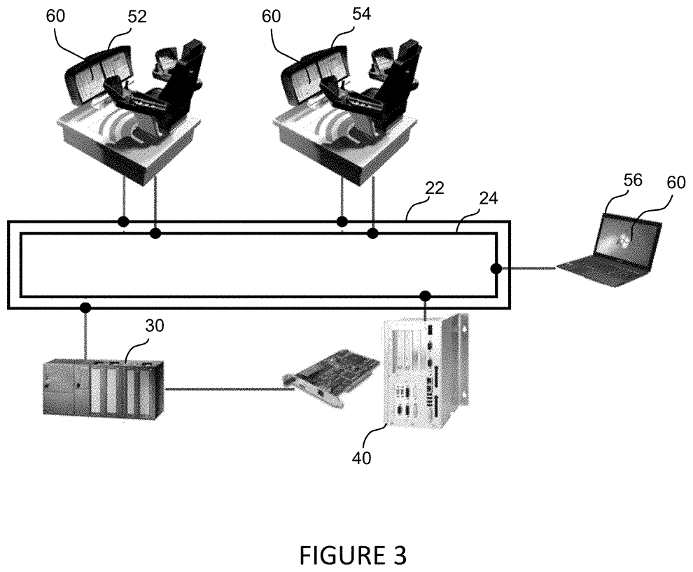

FIG. 3 shows a system diagram of torque turn system, including: sensors, torque turn server, and torque turn analyzers. The system may include a fiber optic redundant ring, comprising C-NET 22 and I-NET 24. In one embodiment of the invention, there are three torque turn analyzer client applications simultaneously connected to a torque turn server 40. First and second torque turn analyzers 52 and 54, respectively, may communicate via both the C-NET 22 and I-NET 24. A remote torque turn analyzer 56 may communicate via the I-NET 24. The torque turn server 40 may communicate via the I-NET 24. Sensors 30 may communicate via the C-NET 22. Sensors 30 may also communicate with an applicomIO PCU-DPIO card in the torque turn server 40 via a profibus DP 26, which may transmit at high speed (2-3 ms).

The sensors 30 may comprise PLCs and may be hardwired and/or bus. The sensors 30 may include programmable logic controllers (PLCs), processors, industrial computers, personal computer based controllers, soft PLCs, the like, and/or any example controller configured and operable to receive sensor data from torque sensor 14 and turn sensor 16. Sensors 30 may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. Sensor data and/or status data may be communicated through virtual networks and a common data bus between direct controllers of different subsystems. Sensors 30 may be programmed and deployed , but with relative difficulty. Programmed software may thereafter be configured and edited, but with relative difficulty. Only very rigid computer programing is possible. A field bus may be used to communicate with sensors 30 via protocols, such as Ethernet CAT, ProfiNET, ProfiBus, Modbus, etc.

The torque turn server 40 may comprise a variety of computing devices, for example, computers, such as industrial PC, processors, domain controllers, programmable logic controllers (PLCs), industrial computers, personal computers based controllers, soft PLCs, the like, and/or any example controller configured and operable to receive information and data available on a network, and transmit control commands and instructions to lower level controllers, which directly control subsystem equipment. Torque turn server 40 may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor include one or more INTEL microprocessors, microcontrollers from the ARM and/or PICO families of microcontrollers, embedded soft/hard processors in one or more FPGAs, etc. Torque turn server 40 may be programmed and deployed relatively easily as high level programming languages, such as C/C++, may be used with software program running in a real time operating system (RTOS). A real time communication databus is used to communicate with torque turn server 40 via protocols, such as TCP/IP and UDP. The torque turn server may run on a computer system having the following minimum requirements: Windows WP Professional for Embedded Systems—SP1—32-bit; SQL Server 2008 R2 SP1—Express Edition 32-bit; .NET Framework 4; and ApplicomIO v3.2 (driver, API and OPC Server).

First and second torque turn analyzers 52 and 54 and remote torque turn analyzer 56 may comprise a variety of computing devices, for example, computers, such as industrial PC, processors, domain controllers, programmable logic controllers (PLCs), industrial computers, personal computer based controllers. Each may have associated therewith a visual display of any size or shape known in the industry. Further, each may have any input or interface device known in the industry, such as key board, joy stick, mouse, touch screen, voice activated, eye activated, etc. Each torque turn analyzer 52, 54 and 56 may display a graphic user interface 60 to the operator. Each torque turn analyzer client application may run on a computer system with the following minimum requirements: Windows WP Professional for Embedded Systems —SP1—32-bit; and .NET Framework 4. The processor may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute instructions for the GUI, as well as providing any other functions of the system. Memory may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, and/or any other type of volatile or non-volatile memory or storage device. The computer code instructions for the system may comprise application software, firmware, and/or any other type of computer-readable instructions and/or any related, required, or useful applications, plug-ins, readers, viewers, updates, patches, or other code for executing the application may be downloaded via the Internet or installed in any other known manner.

First and second torque turn analyzers 52 and 54 and remote torque turn analyzer 56 may comprise any type of display device for displaying information related to the GUI, such as for example, an LCD screen (e.g., thin film transistor (TFT) LCD or super twisted nematic (STN) LCD), an organic light-emitting diode (OLED) display, or any other suitable type of display. In some embodiments, display may be an interactive display (e.g., a touch screen) that allows a user to interact with the GUI. In other embodiments, display may be strictly a display device, such that all user input is received via other input/output devices.

First and second torque turn analyzers 52 and 54 and remote torque turn analyzer 56 may comprise a any input/output devices, which may include any suitable interfaces allowing a user to interact with the GUI. For example, input/output devices may include a touch screen, physical buttons, joystick, sliders, switches, data ports, keyboard, mouse, voice activated interfaces, or any other suitable devices.

The computer systems running the torque turn server and the torque turn analyzer applications may have their clocks synchronized with the rig time. Clock synchronization may be configured and verified at network and computer setup level when the applications are installed.

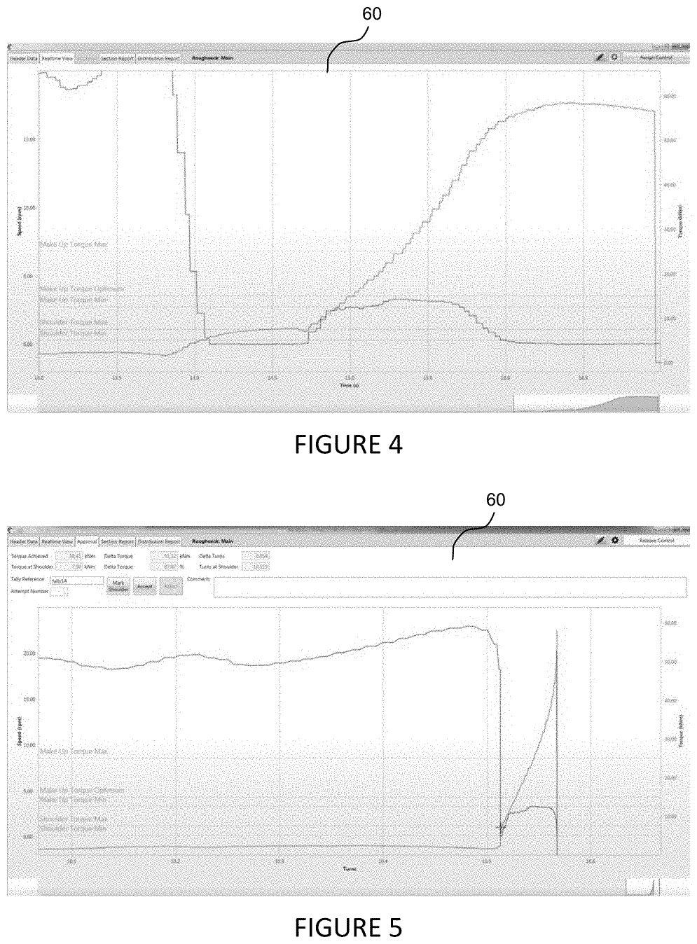

FIG. 4 shows a graphic user interface GUI 60 of the torque turn system 20, which may be illuminated on the display 32 of the computer 30. The GUI 60 comprises several screen views organized by navigation tabs, including: header data 62, real-time view 64, approval 66, section report 68, and distribution report 70. The torque turn system supports a multi-client real-time visualization of the casing operation.

FIG. 4 shows an output component of a real-time chart presented in the GUI 60, to enable operators to follow the tubular make-up operation in detail. The real-time view 64 may include output components that indicate: shoulder torque min, shoulder torque max, make up torque min, make up torque optimum, and make up torque max. The real-time view 64 may also provide an output component that simultaneously graphs in real time: (i) speed (rpm) as a function of time (s); and (ii) torque (kNm) as a function of time (s).

FIG. 5 shows the graphic user interface GUI 60 displaying an approval screen 66. An assigned supervisor has the ability to analyze each connection in a separate approval view once the connection has been completed. An output component may display the connection data in a turn-based chart, wherein speed (rpm) and torque (kNm) are plotted against turns. This allows the supervisor to easily analyze and approve or reject the connection via “accept” and “reject” input components of the GUI. The approval view may also show output components of the necessary calculated data to aid the decision process and a comment field for notes regarding the connection. Calculated data may include: torque achieved, torque at shoulder, delta torque (kNm), delta torque (%), delta turns, turns at shoulder, tally reference, and attempt number. For each approved/rejected connection a .pdf report may be generated containing all metadata, calculations and connection graphs. The approval view 66 may also include output components that indicate: shoulder torque min, shoulder torque max, make up torque min, make up torque optimum, and make up torque max. The approval view 66 may simultaneously graph via output components: (i) speed (rpm) as a function of turns; and (ii) torque (kNm) as a function of turns. Active buttons (input components) in the GUI allow the user to: “March Shoulder,” “Accept,” and “Reject.” The GUI 60 further provides a comment field (input component) for the user to add comments regarding the pipe connection.

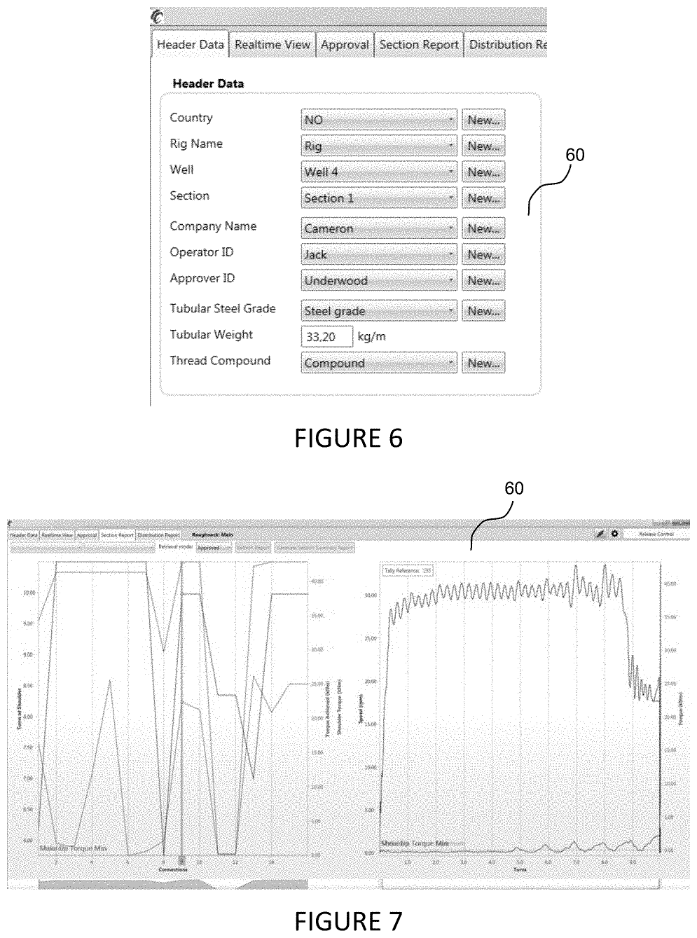

FIG. 6 illustrates the GUI 60 with the header data 62 screen view selected. Pull down menus are provided to allow a user to select: country, rig name, well, section, company name, operator ID, approver ID, tubular steel grade, tubular weight, and thread compound. “New” active buttons (input components) may be selected to add new entries to the pull down menus.

FIG. 7 illustrates the GUI 60 with the section report 68 screen view selected. The section report 68 screen view displays two graphs. The connections graph 72 plots, as a function of connections, several data values, including: turns at shoulder, torque achieved (kNm) and shoulder torque (kNm). The turns graph 74 plots, as a function of turns, several data values, including: speed (rpm) and torque (kNm).

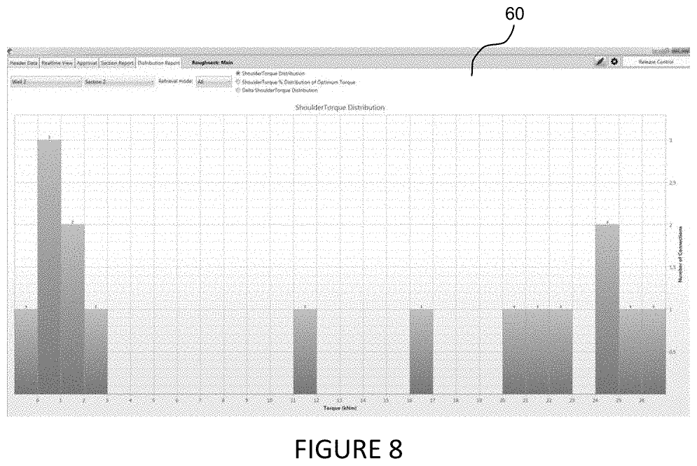

FIG. 8 illustrates the GUI 60 with the shoulder torque distribution report 70 screen view selected. The number of connections may be displayed as a function of torque (kNm) for: shoulder torque, shoulder torque % of optimum torque, or delta shoulder torque. The distribution may be selected by well and section.

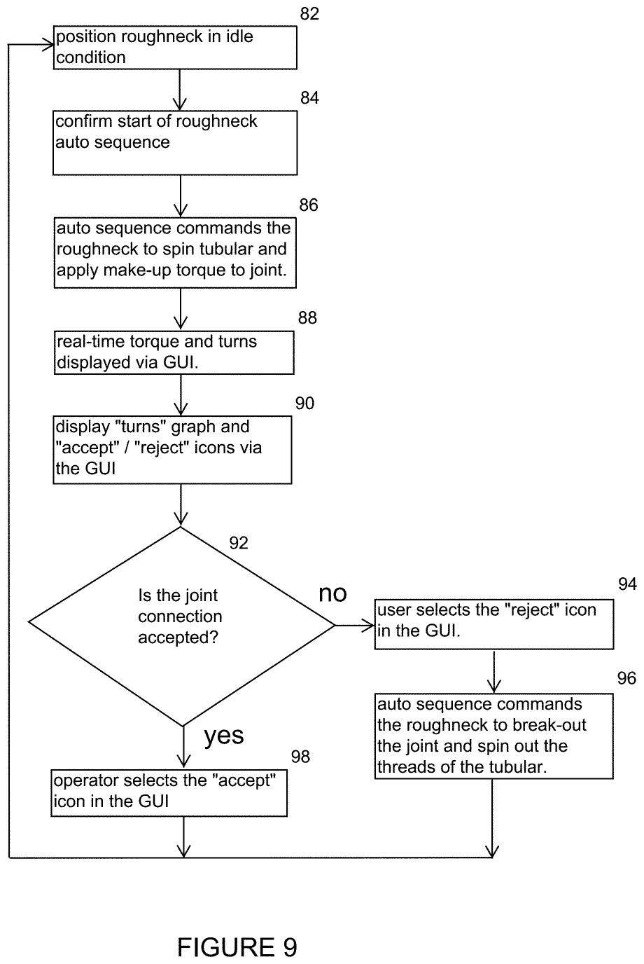

FIG. 9 illustrates a flow chart for a process algorithm for an embodiment of the invention.

The process begins with the roughneck being positioned 82 in an idle condition. In particular, the roughneck is parked away from the well center to clear the way for pipe handling operation. For example, if pipe is being tripped into the wellbore, the drill string is lowered until a portion of the drill string extends above the drill floor to a stick-up height, and a new section of pipe tubular may be positioned directly over the drill sting to be made-up thereto. The operator confirms 84 a start of the roughneck auto sequence for a make-up auto sequence for a pipe joint. The auto sequence then positions 86 the roughneck the tubular joint, spins a tubular to thread the joint, and then applies a make-up torque to the joint. The auto sequence may be accomplished by any known system or method, such as those disclosed in U.S. Pat. Nos. 9,464,492; 9,657,539; and WO 2016/106294, the entire disclosures of which are incorporated herein by reference. The system displays 88 real-time torque and turns via the GUI 60 during the make-up operation. The system then presents 90, via the graphic user interface GUI, a display of the turns graph and input components for acceptance or rejection of the joint connection. The operator may then determine 72 whether the joint connection is accepted. If the joint connection is not accepted (NO), then the operator selects 94 the “reject” input component in the GUI 60. The auto sequence system then commands 96 the roughneck to break-out the joint connections and spin out the threads of the joint tubulars. If the joint connection is accepted (YES), then the operator selects 98 the “accept” input component in the GUI 60. Finally, the auto sequence then commands 82 the roughneck to return to a position for an idle condition.

The description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

If used herein, the term “substantially” is intended for construction as meaning “more so than not.”

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

Although the disclosed embodiments are described in detail in the present disclosure, it should be understood that various changes, substitutions and alterations can be made to the embodiments without departing from their spirit and scope.

What is claimed is:

1. A torque turn system for making pipe joints of tubulars in a drill string relative to a drilling rig, the torque turn system comprising:
a sensor of rotation of a first tubular relative to a second tubular;
a sensor of torque applied to a first tubular relative to a second tubular;
a torque turn server in data communication with the sensor of rotation and the sensor of torque, the torque turn server comprising a processor, a non-transitory storage medium, a transmitter/receiver, and a set of computer readable instructions stored in the non-transitory storage medium and when executed by the processor: (i) receive and process real-time rotation data from the sensor of rotation; and (ii) receive and process real-time torque data from the sensor of torque; and
a torque turn analyzer in data communication with the torque turn server, the torque turn analyzer comprising a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising:
a rotation data output component;
a torque data output component;
an accept input component; and
a reject input component.

2. The torque turn system for making pipe joints of tubulars in a drill string relative to a drilling rig as claimed in claim 1, wherein the rotation data output component comprises a plot of the rotation data as a function of turns, wherein the torque data output component comprises a plot of the torque data as a function of turns.

3. The torque turn system for making pipe joints of tubulars in a drill string relative to a drilling rig as claimed in claim 1, wherein the accept input component comprises a button, wherein the reject input component comprises a button.

4. The torque turn system for making pipe joints of tubulars in a drill string relative to a drilling rig as claimed in claim 1, wherein the GUI further comprises: a real-time rotation data output component and a real-time torque data output component.

5. The torque turn system for making pipe joints of tubulars in a drill string relative to a drilling rig as claimed in claim 4, wherein the real-time rotation data output component comprises a plot of rotation data as a function of time, wherein the real-time torque data output component comprises a plot of torque data as a function of time.

6. The torque turn system for making pipe joints of tubulars in a drill string relative to a drilling rig as claimed in claim 1, wherein the GUI further comprises at least one output component selected from a torque achieved output component, a torque at shoulder output component, a delta torque amount output component, a delta torque percent output component, a delta turns output component, and a turns at shoulder output component.

7. The torque turn system for making pipe joints of tubulars in a drill string relative to a drilling rig as claimed in claim 1, wherein the torque turn analyzer is a first torque analyzer and the system further comprises a second torque turn analyzer, wherein the second torque turn analyzer is in data communication with the torque turn server, wherein the second torque turn analyzer comprises a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising:
a rotation data output component;
a torque data output component;
an accept input component; and
a reject input component;
wherein the GUIs of both the first and second torque turn analyzers each further comprise a control input component, wherein an input to the control input component in a GUI of the first torque turn analyzer enables the accept and reject input components in the first torque turn analyzer and disables the accept and reject input components in the second torque turn analyzer.

8. A torque turn method for making a pipe joint of tubulars in a drill string relative to a drilling rig, the torque turn method comprising:
making up a joint between two tubulars by spinning the tubulars relative to each other and applying torque to the tubulars relative to each other;
sensing tubular relative rotation and tubular relative torque to obtain rotation data and torque data;
generating a graphic user interface (GUI) comprising: a rotation data output component; a torque data output component; an accept input component; and a reject input component.

9. A torque turn method for making a pipe joint of tubulars in a drill string relative to a drilling rig, as claimed in claim 8, wherein the rotation data output component comprises a plot of the rotation data as a function of turns, wherein the torque data output component comprises a plot of the torque data as a function of turns.

10. A torque turn method for making a pipe joint of tubulars in a drill string relative to a drilling rig, as claimed in claim 8, wherein the accept input component comprises a button, wherein the reject input component comprises a button.

11. A torque turn method for making a pipe joint of tubulars in a drill string relative to a drilling rig, as claimed in claim 8, wherein the GUI further comprises: a real-time rotation data output component and a real-time torque data output component.

12. A torque turn method for making a pipe joint of tubulars in a drill string relative to a drilling rig, as claimed in claim 11, wherein the real-time rotation data output component comprises a plot of rotation data as a function of time, wherein the real-time torque data output component comprises a plot of torque data as a function of time.

13. A torque turn method for making a pipe joint of tubulars in a drill string relative to a drilling rig, as claimed in claim 8, wherein the GUI further comprises at least one output component selected from a torque achieved output component, a torque at shoulder output component, a delta torque amount output component, a delta torque percent output component, a delta turns output component, and a turns at shoulder output component.

14. A torque turn method for making a pipe joint of tubulars in a drill string relative to a drilling rig, as claimed in claim 8, wherein the GUI further comprises a control input component, wherein an input to the control input component enables the accept and reject input components.

15. A torque turn system for making a pipe joint of tubulars in a drill string relative to a drilling rig, the torque turn system comprising:
a sensor of rotation of a first tubular relative to a second tubular;
a sensor of torque applied to a first tubular relative to a second tubular;
a torque turn server in data communication with the sensor of rotation and the sensor of torque, the torque turn server comprising a processor, a non-transitory storage medium, a transmitter/receiver, and a set of computer readable instructions stored in the non-transitory storage medium and when executed by the processor: (i) receive and process real-time rotation data from the sensor of rotation; and (ii) receive and process real-time torque data from the sensor of torque; and
a torque turn analyzer in data communication with the torque turn server, the torque turn analyzer comprising a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising:
a rotation data output component, wherein the rotation data output component comprises a plot of the rotation data as a function of turns;
a torque data output component, wherein the torque data output component comprises a plot of the torque data as a function of turns;
an accept input component;
a reject input component;
a real-time rotation data output component, wherein the real-time rotation data output component comprises a plot of rotation data as a function of time; and
a real-time torque data output component, wherein the real-time torque data output component comprises a plot of torque data as a function of time.

16. The torque turn system for making pipe joints of tubulars in a drill string relative to a drilling rig as claimed in claim 15, wherein the accept input component comprises a button, wherein the reject input component comprises a button.

17. The torque turn system for making pipe joints of tubulars in a drill string relative to a drilling rig as claimed in claim 15, wherein the GUI further comprises at least one output component selected from a torque achieved output component, a torque at shoulder output component, a delta torque amount output component, a delta torque percent output component, a delta turns output component, and a turns at shoulder output component.

18. The torque turn system for making pipe joints of tubulars in a drill string relative to a drilling rig as claimed in claim 15, wherein the torque turn analyzer is a first torque analyzer and the system further comprises a second torque turn analyzer, wherein the second torque turn analyzer is in data communication with the torque turn server, wherein the second torque turn analyzer comprises a processor, a non-transitory storage medium, a display, a transmitter/receiver, and a set of computer readable instructions stored in the non-transitory storage medium and when executed by the processor: (i) receive processed rotation data from the torque turn server; (ii) receive processed torque data from the torque turn server; and (iii) generate a graphical user interface (GUI), the GUI comprising:
a rotation data output component, wherein the rotation data output component comprises a plot of the rotation data as a function of turns,;
a torque data output component, wherein the torque data output component comprises a plot of the torque data as a function of turns;
an accept input component;
a reject input component;
a real-time rotation data output component, wherein the real-time rotation data output component comprises a plot of rotation data as a function of time; and
a real-time torque data output component, wherein the real-time torque data output component comprises a plot of torque data as a function of time;
wherein the GUIs of both the first and second torque turn analyzers each further comprise a control input component, wherein an input to the control input component in a GUI of the first torque turn analyzer enables the accept and reject input components in the first torque turn analyzer and disables the accept and reject input components in the second torque turn analyzer.
